(19) United States
(12) Patent Application Publication
(10) Pub. No.: US 2017/0168964 A1
(43) Pub. Date: Jun. 15, 2017

(54) HARD DRIVE DISK INDICATOR PROCESSING APPARATUS

(71) Applicant: Compal Electronics, Inc., Taipei (TW)

(72) Inventors: Te-Ming Kung, Taipei (TW); Chang-Yu Tu, Taipei (TW); Wen-Shyan Lai, Taipei (TW)

(21) Appl. No.: 15/373,481

(22) Filed: Dec. 9, 2016

Related U.S. Application Data
(60) Provisional application No. 62/267,859, filed on Dec. 15, 2015.

(51) Int. Cl. G06F 13/10; G06F 13/40; G06F 13/42; G06F 13/20

(52) U.S. Cl. CPC G06F 13/102; G06F 13/20; G06F 13/4068; G06F 13/4282

(57) ABSTRACT

A hard drive disk indicator processing apparatus includes first and second processors. The first processor includes first, second and third communication interfaces. The first communication interface receives at least one serial general purpose input/output signal from a motherboard. The second communication interface receives a plurality piece of hard drive disk status information for responding to a plurality of hard drive disk statuses of hard drive disks. The third communication interface outputs serial information. The second processor includes fourth and fifth communication interfaces. The fourth communication interface is coupled to the third communication interface and receives the serial information. The fifth communication interface is coupled to a plurality of hard drive disk indicators. The first processor generates the serial information according to the at least one serial general purpose input/output signal. The second processor controls an on/off status of each of the hard drive disk indicators according to the serial information.

### FIELD OF THE INVENTION

The present invention relates to processing of hard drive disk indicator signals in the field of computer technology, and more particularly to a hard drive disk indicator processing apparatus.

### BACKGROUND OF THE INVENTION

The current design of the hard drive disk backboard can be divided into a structure of micro control unit (MCU), a structure of backboard controller and a structure of complex programmable logic device (CPLD). Among them, the micro control unit is less capable of processing a plurality set of serial general purpose input/output (SGPIO) signals. Specifically, one micro control unit can only interpret up to four hard drive disk signals, and one micro control unit needs to perform at least three operations: interpreting the serial general purpose input/output signal, flashing LED and transmitting information. Therefore, eight micro control units are required if there are thirty two hard drive disks to be supported. In addition, if the structure of backboard controller is used to support the thirty two hard drive disks, a plurality of backboard controllers are also required; and therefore, the cost is increased and the circuit design is more complex. In addition, although the complex programmable logic device can process a plurality set of serial general purpose input/output signals, the price of complex programmable logic device is much higher than the micro control unit.

The above three structures are expensive and the circuit design is complicated. If the number of hard drive disks increases or decreases, the complexity of the circuit modification is increased, and the updating of the firmware (F/W) is complicated and time consuming accordingly.

### SUMMARY OF THE INVENTION

In order to improve the above-described drawbacks, the present invention provides a hard drive disk indicator processing apparatus, which includes a first processor and a second processor. The first processor includes a first communication interface, a second communication interface and a third communication interface. The first communication interface receives at least one serial general purpose input/output signal from a motherboard. The second communication interface receives a plurality piece of hard drive disk status information for responding to a plurality of hard drive disk statuses of a plurality of hard drive disks. The third communication interface outputs serial information. The second processor includes a fourth communication interface and a fifth communication interface. The fourth communication interface is electrically coupled to the third communication interface and receives the serial information. The fifth communication interface is electrically coupled to a plurality of hard drive disk indicators. The first processor generates the serial information according to the at least one serial general purpose input/output signal. The second processor controls an on/off status of each of the hard drive disk indicators according to the serial information, respectively.

In summary, the hard drive disk indicator processing apparatus of the present invention utilizes the first processor to process the serial general purpose input/output signal, utilizes the second processor to control the on/off statuses of the hard drive disk indicators, and provides and transmits related integrated information to the motherboard. Because only two processors are required to control the on/off statuses of a plurality of hard drive disk indicators, the cost is reduced, the power consumption is lowered and the circuit design is simplified. In addition, firmware update can be performed only for the second processor. Moreover, when the total number of hard drive disks increases or decreases, the modification of circuit is easier.

### BRIEF DESCRIPTION OF THE DRAWING

FIG. 1 is a schematic diagram of a hard drive disk indicator processing apparatus in accordance with an embodiment of the present invention;

FIG. 2 is a schematic diagram of a hard drive disk indicator processing apparatus in accordance with another embodiment of the present invention; and

FIG. 3 is a schematic diagram of a hard drive disk indicator processing apparatus in accordance with still another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

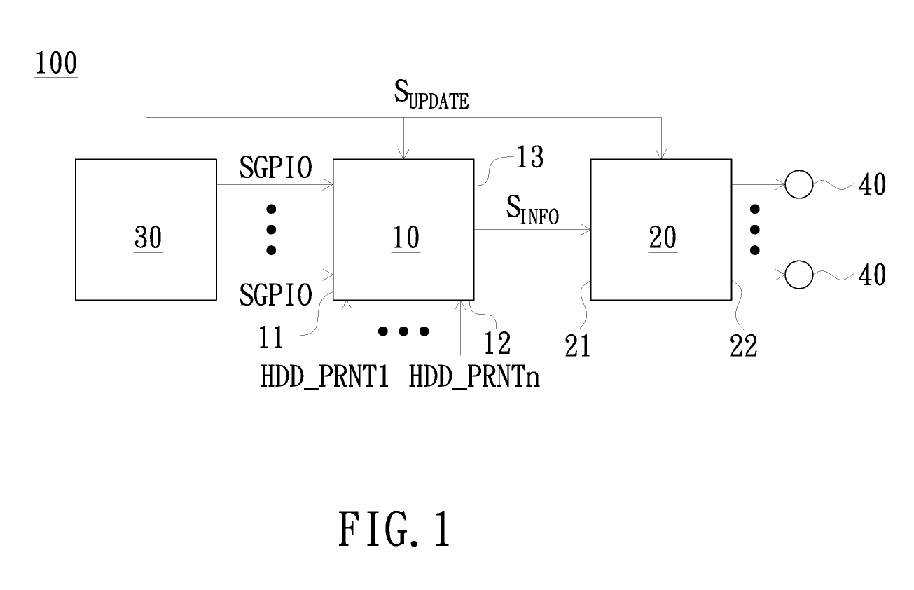

FIG. 1 is a schematic diagram of a hard drive disk indicator processing apparatus 100 in accordance with an embodiment of the present invention. As shown in FIG. 1, the hard drive disk indicator processing apparatus 100 includes a motherboard 30, a first processor 10 and a second processor 20. The first processor 10 and the second processor 20 are embedded in a hard drive disk backboard (not shown). In the present embodiment, the hard drive disk backboard is connected to the motherboard 30 via a bus such as peripheral component interconnect express (PCIE) or serial advanced technology attachment (SATA). In addition, the hard drive disk indicator processing apparatus 100 may further include a plurality of hard drive disks, which are respectively connected to the hard drive disk backboard and the motherboard 30 via the buses; however, it is to be noted that the signal data transmitted between the hard drive disks and the hard drive disk backboard is different with the signal data transmitted between the hard drive disks and the motherboard 30.

In the present embodiment, the first processor 10 includes a first communication interface 11, a second communication interface 12 and a third communication interface 13. The first communication interface 11 receives a serial general purpose input/output signal SGPIO from the motherboard 30. The second communication interface 12 receives hard drive disk status information HDD_PRNT1 to HDD_PRNTn for responding to a plurality of hard drive disk statuses. The third communication interface 13 outputs serial information S_{INFO}. The second processor 20 includes a fourth communication interface 21 and a fifth communication interface 22. The fourth communication interface 21 is electrically coupled to the third communication interface 13 and receives the serial information S_{INFO}. The fifth communication interface 22 is electrically coupled to hard drive disk indicators 40 corresponding to a plurality of hard drive disks. The hard drive disk indicator 40 may be, for example, an LED, but the present invention is not limited thereto.

The first processor 10 generates the serial information S_{INFO} according to the serial general purpose input/output signal SGPIO. The second processor 20 receives the serial information S_{INFO} and controls the on/off status of each of the hard drive disk indicators 40 according to the serial information S_{INFO}, respectively. Specifically, in general, each single hard drive disk uses two or three hard drive disk indicators 40 to indicate its hard drive disk status. When a plurality of hard drive disks are electrically coupled to the motherboard 30, the motherboard 30 sends the serial general purpose input/output signal SGPIO having hard drive disk indicator display information corresponding to a plurality of hard drive disk indicators 40 to the first processor 10. Thereafter, after analyzing the received serial general purpose input/output signal SGPIO to determine which hard drive disks are corresponded by the serial general purpose input/output signal SGPIO, the first processor 10 generates and transmits the serial information S_{INFO} to the second processor 20. Thereafter, the second processor 20 respectively controls the on/off status of the corresponding hard drive disk indicator 40 in accordance with the serial information S_{INFO}.

Specifically, the first processor 10 integrates the received serial general purpose input/output signal SGPIO with the received hard drive disk status information HDD_PRNT1 to HDD_PRNTn to generate the serial information S_{INFO}. Herein, the hard drive disk status information HDD_PRNT1 to HDD_PRNTn provides at least information about the presence or absence of a plurality of hard drive disks. Further, the hard drive disk status information HDD_PRNT1 to HDD_PRNTn may provide more information about the corresponding hard drive disks in the form of packet, and the processor 10 integrates the hard drive disk status information HDD_PRNT1 to HDD_PRNTn with the hard drive disk display information of each hard drive disk to generate the serial information S_{INFO}.

In some embodiments, the aforementioned controlling, by the second processor 20, of the on/off status of the hard drive disk indicators 40 based on the serial information S_{INFO} is implemented by mapping the hard drive disk indicator display information of each hard drive disk to a hard drive disk status table. For example, the first processor 10 parses the serial general purpose input/output signal SGPIO to obtain a plurality of three-bit hard drive disk indicator display information, where each hard drive disk indicator display information indicates the hard drive disk status of two or three hard drive disk indicators 40 of single hard drive disk. The first processor 10 then transmits the plurality of hard drive disk indicator display information to the second processor 20 with the serial information S_{INFO}.

Thereafter, the second processor 20 maps the hard drive disk indicator display information of each hard drive disk to the hard drive disk status table as shown in Table 1 to determine the on/off status of the hard drive disk indicators 40. In Table 1, each one of the three bits of the hard drive disk indicator display information is “0” or “1”; therefore, the hard drive disk status table may include six hard drive disk statuses, which are: a status of hard drive disk existing and in access (Activity), a status of hard drive disk existing and not in access (No Activity), a status of hard drive disk existing and executing instruction (No Fail, Locate or Rebuild), a status of hard drive disk existing and having error (Fail), a status of in operation (Locate) and a status of rebuilding (Rebuild). For example, if the three bits of hard drive indicator display information is “100”, it is indicated that the status of this particular hard drive disk is “Activity”, but the present invention is not limited thereto. In another embodiment, each one of the three bits of the hard drive disk indicator display information may be “0”, “1” or “X”, wherein “X” indicates that the bit need not be considered. The representation of the three bits of the hard drive disk indicator display information or the hard drive disk status table can be determined based on the needs of the user, and the present invention is not limited thereto.

TABLE 1

| the three bits of hard | | | |
|---|---|---|---|
| drive disk indicator | | | |
| display information | | | |
| first bit | second bit | third bit | hard drive disk status |
| 1 | 0 | 0 | Activity |
| 0 | 1 | 0 | No Activity |
| 0 | 0 | 0 | No Fail, Locate or Rebuild |
| 1 | 1 | 0 | Locate |
| 1 | 0 | 1 | Fail |
| 1 | 1 | 1 | Rebuild |

Furthermore, as shown in Table 2, the information on each of the six hard drive disk statuses can be pre-set and accordingly the second processor 20 controls the display status of the two hard drive disk indicators of single hard drive disk, that is, controls the display status of the two hard drive disk indicators “Activity LED” and “Status LED”. For example, after the first processor 10 analyzes that the three-bit hard drive disk indicator display information is “111” and transmits it to the second processor 20, the second processor 20 may determine, based on the hard drive disk status table (that is, the Table 1), that the hard drive disk status corresponding to the received hard drive disk indicator display information is “Rebuild”, and accordingly the second processor 20 respectively controls the display status of the two hard drive disk indicators as: flashing the hard drive disk indicator “Activity LED” at a frequency of 4 Hz and flashing the hard drive disk indicator “Status LED” at a frequency of 1 Hz. In the present embodiment, the display status “OFF” in Table 2 indicates that the status of the corresponding hard drive disk indicator is off. However, Table 2 is for illustrative purposes only, and the present invention is not limited thereto. In other words, one of ordinary skill in the art should be able to preliminarily set the information of the display status of the two hard drive disk indicators in each of the six hard drive disk statuses according to the actual implementation requirements.

TABLE 2

display status of two hard
drive disk indicators

| hard drive disk status | Activity LED | Status LED |
|---|---|---|
| Activity | 4 Hz | OFF |
| No Activity | ON | OFF |
| No Fail, Locate or Rebuild | OFF | OFF |
| Locate | ON | 4 Hz |
| Fail | ON | ON |
| Rebuild | 4 Hz | 1 Hz |

Alternatively, as shown in Table 3, the information on each of the six hard drive disk statuses may be pre-set and the second processor 20 controls the display status of the three hard drive disk indicators of single hard drive disk accordingly, that is, controls the display status of the three hard drive disk indicators “Activity LED”, “Locate LED” and “Fail LED”. In the present embodiment, the display status “OFF” in Table 3 indicates that the status of the corresponding hard drive disk indicator is off, and the display status “X” in Table 3 indicates that the status of the corresponding hard drive disk indicator does not need to be considered, but the present invention is not limited thereto and depends on the user's needs.

TABLE 3

| | display status of three | | |
|---|---|---|---|
| hard drive disk | hard drive disk indicators | | |
| status | Activity LED | Locate LED | Fail LED |
| Activity | 4 Hz | X | X |
| No Activity | ON | X | X |
| No Fail, Locate | OFF | X | X |
| or Rebuild | | | |
| Locate | X | 4 Hz | OFF |
| Fail | X | OFF | ON |
| Rebuild | X | OFF | 1 Hz |

In some embodiments, the first processor 10 is a complex programmable logic device and the second processor 20 is a micro control unit. Alternatively, both of the first processor 10 and the second processor 20 are implemented as micro control units.

In some embodiments, after interpreting one or more sets of serial general purpose input/output signals SGPIO, the first processor 10 may transmit related data to the second processor 20 via a transmission interface such as an inter-integrated circuit bus (I²C), a universal asynchronous receiver/transmitter (UART) or a serial peripheral interface (SPI).

In addition, the motherboard 30 may send an update signal S_{UPDATE} to the first processor 10 or the second processor 20 via a transmission interface such as an I²C, a UART, a joint test action group (JTAG) transmission interface or a SPI for updating the firmware (F/W) of the first processor 10 or the second processor 20. It is to be noted that since the present invention mainly uses the second processor 20 to control the status of the hard drive disk indicator 40, the aforementioned firmware update may be performed only for the second processor 20.

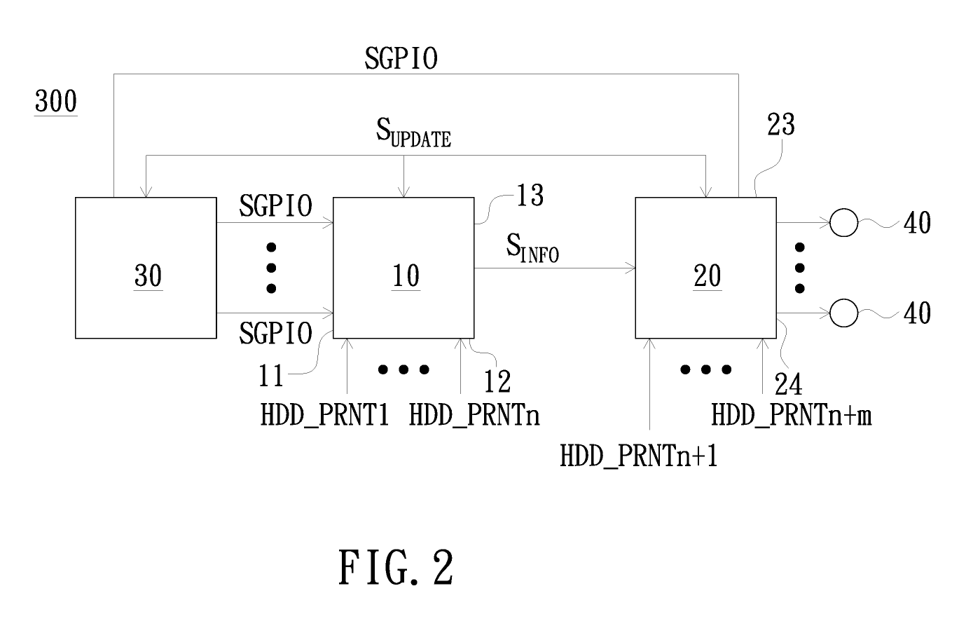

FIG. 2 is a schematic diagram of a hard drive disk indicator processing apparatus 300 in accordance with another embodiment of the present invention. As shown in FIG. 2, the hard drive disk indicator processing apparatus 300 of the present embodiment is different from the hard drive disk indicator processing apparatus 100 in that the second processor 20 of the hard drive disk indicator processing apparatus 300 is further coupled to a plurality of extended hard drive disks. Specifically, when the total number of hard drive disks increases, the second processor 20 may also receive the serial general purpose input/output signal SGPIO from the motherboard 30 via a sixth communication interface 23 and receive extended hard drive disk status information HDD_PRNTn+1 to HDD_PRNTn+m for responding to a plurality of extended hard drive disk statuses via a seventh communication interface 24. In addition, the second processor 20 controls the on/off statuses of the hard drive disk indicators 40 of the extended hard drive disks according to the serial general purpose input/output signal SGPIO from the motherboard 30. That is, in addition to receiving the serial information S_{INFO} from the first processor 10 and controlling the on/off statuses of the hard drive disk indicators 40 according to the serial information S_{INFO}, the second processor 20 further receives and interprets at least one set of serial general purpose input/output signals SGPIO and controls the flashing of the corresponding hard drive disk indicators 40.

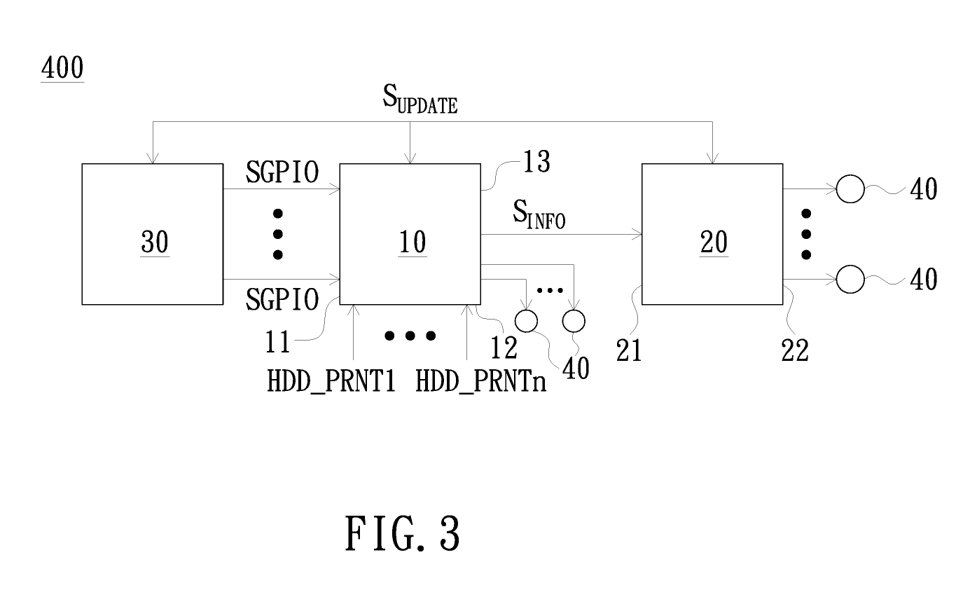

FIG. 3 is a schematic diagram of a hard drive disk indicator processing apparatus 400 in accordance with still another embodiment of the present invention. As shown in FIG. 3, the hard drive disk indicator processing apparatus 400 of the present embodiment is different from the hard drive disk indicator processing apparatuses 100 and 300 in that in addition to receiving and interpreting one or more sets of serial general purpose input/output signals SGPIO and transmitting the serial information S_{INFO} to the second processor 20 via a transmission interface such as an I²C, a UART or a SPI, the first processor 10 of the hard drive disk indicator processing apparatus 400 further controls the flashing of a portion of the hard drive disk indicators 40. Specifically, in the hard drive disk indicator processing device 400, the second processor 20 controls the on/off status of most of the hard drive disk indicators 40 based on the serial information S_{INFO}, and the first processor 10 controls the on/off status of the remaining hard drive disk indicators 40. In other words, the first processor 10 is still primarily responsible for interpreting the serial general purpose input/output signal SGPIO while the second processor 20 is primarily responsible for controlling the flashing of most of the hard drive disk indicators 40.

In summary, the hard drive disk indicator processing apparatus of the present invention utilizes the first processor to process the serial general purpose input/output signal, utilizes the second processor to control the on/off status of the hard drive disk indicators, and provide and transmit related integrated information to the motherboard. Because only two processors are required to control the on/off status of a plurality of hard drive disk indicators, the cost is reduced, the power consumption is lowered and the circuit design is simplified. In addition, firmware update can be performed only for the second processor. Moreover, when the total number of hard drive disks increases or decreases, the modification of circuit is easier.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A hard drive disk indicator processing apparatus, comprising:
a first processor, comprising a first communication interface, a second communication interface and a third communication interface, wherein the first communication interface receives at least one serial general purpose input/output signal from a motherboard, the second communication interface receives a plurality piece of hard drive disk status information for responding to a plurality of hard drive disk statuses of a plurality of hard drive disks, and the third communication interface outputs serial information; and
a second processor, comprising a fourth communication interface and a fifth communication interface, wherein the fourth communication interface is electrically coupled to the third communication interface and receives the serial information, and the fifth communication interface is electrically coupled to a plurality of hard drive disk indicators,
wherein the first processor generates the serial information according to the at least one serial general purpose input/output signal, and the second processor controls an on/off status of each of the hard drive disk indicators according to the serial information, respectively.

2. The hard drive disk indicator processing apparatus according to claim 1, wherein the first processor is a micro control unit.

3. The hard drive disk indicator processing apparatus according to claim 1, wherein the first processor is a complex programmable logic device.

4. The hard drive disk indicator processing apparatus according to claim 1, wherein the second processor is a micro control unit.

5. The hard drive disk indicator processing apparatus according to claim 1, wherein the plurality piece of hard drive disk status information are used to response to a presence of each of the hard drive disks, the at least one serial general purpose input/output signal comprises a plurality piece of hard drive disk indicator display information, and the first processor integrates the plurality piece of hard drive disk indicator display information with the plurality piece of hard drive disk status information to generate the serial information.

6. The hard drive disk indicator processing apparatus according to claim 5, wherein after receiving the serial information, the second processor determines the on/off status of the hard drive disk indicators by mapping the plurality piece of hard drive disk indicator display information to a hard drive disk status table.

7. The hard drive disk indicator processing apparatus according to claim 6, wherein the hard drive disk status table comprises a status of hard drive disk existing and in access, a status of hard drive disk existing and not in access, a status of hard drive disk existing and executing instruction, a status of hard drive disk existing and having error, a status of in operation and a status of rebuilding.

8. The hard drive disk indicator processing apparatus according to claim 1, wherein a portion of the hard drive disk indicators is electrically coupled to the first processor, and the first processor controls the on/off status of the portion of the hard drive disk indicators electrically coupled to the first processor according to the at least one serial general purpose input/output signal.

9. The hard drive disk indicator processing apparatus according to claim 1, wherein the second processor further comprises a sixth communication interface and a seventh communication interface, the sixth communication interface receives another serial general purpose input/output signal from the motherboard, the seventh communication interface receives a plurality piece of extended hard drive disk status information for responding to a plurality of extended hard drive disk statuses of a plurality of extended hard drive disks, and the second processor controls the on/off statuses of the hard drive disk indicators of the extended hard drive disks according to the other serial general purpose input/output signal.

10. The hard drive disk indicator processing apparatus according to claim 1, wherein after interpreting at least one set of the serial general purpose input/output signals, the first processor transmits related data to the second processor via a transmission interface.

11. The hard drive disk indicator processing apparatus according to claim 10, wherein the transmission interface comprises an inter-integrated circuit bus, a universal asynchronous receiver/transmitter or a serial peripheral interface.

12. The hard drive disk indicator processing apparatus according to claim 1, wherein the motherboard further sends an update signal via a transmission interface for updating firmware of at least one of the first processor and the second processor.

13. The hard drive disk indicator processing apparatus according to claim 12, wherein the transmission interface comprises an inter-integrated circuit bus, a universal asynchronous receiver/transmitter, a serial peripheral interface or a joint test action group transmission interface.
